(19) United States
(12) Patent Application Publication
(10) Pub. No.: US 2026/0195121 A1
(43) Pub. Date: Jul. 9, 2026

(54) Machine Generated Code Development Efficiency Ratings and Code Development Insights

(71) Applicant: Verizon Patent and Licensing Inc., Basking Ridge, NJ (US)

(72) Inventors: Dhayanidhi Rajasekaran, Chennai (IN); Nizam Ali, Hyderabad (IN); Kedar Phadke, Hyderabad (IN); Ramji Sundaram, Chennai (IN); Edwin Inbaraj, Chennai (IN)

(21) Appl. No.: 19/015,378

(22) Filed: Jan. 9, 2025

(51) Int. Cl. G06F 8/71; G06F 8/10; G06F 8/77

(52) U.S. Cl. CPC G06F 8/71; G06F 8/10; G06F 8/77

(57) ABSTRACT

One or more computing devices, systems, and/or methods for machine generated code development efficiency ratings and code development insights are provided. Code of a project is evaluated to determine a current state of the code. Actions performed by a user with respect to developing the code are evaluated to generate evaluation metrics for the user. The current state of the code and the evaluation metrics for the user are input into a model that generates an output specifying a rating for the user. The output is used as part of evaluating an efficiency of the user.

### BACKGROUND

An organization may employee numerous developers to work on software projects for developing various types of software for the organization or clients of the organization. For example, a group of developers may collaborate on a financial software project to develop a business forecast application. Each developer may be assigned various tasks to perform for developing the financial forecast application, such a task to develop login security functionality, a task to retrieve and analyze business data from a database, a task to generate charts from the analyzed business data, etc.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for machine generated code development efficiency ratings and code development insights, in accordance with an embodiment of the present technology;

FIG. 2 illustrates an example of a method for machine generated code development efficiency ratings and code development insights, in accordance with an embodiment of the present technology;

FIG. 3A illustrates an example of a system for machine generated code development efficiency ratings and code development insights, where input data for a model is stored into a database, in accordance with an embodiment of the present technology;

FIG. 3B illustrates an example of a system for machine generated code development efficiency ratings and code development insights, where a dashboard interface is populated based upon an output from a model, in accordance with an embodiment of the present technology;

FIG. 3C illustrates an example of a system for machine generated code development efficiency ratings and code development insights, where a dashboard interface is populated based upon an output from a model, in accordance with an embodiment of the present technology;

FIG. 3D illustrates an example of a custom prompt, in accordance with an embodiment of the present technology;

FIG. 4 illustrates an example of a chart of code development efficiency ratings, in accordance with an embodiment of the present technology;

FIG. 5 illustrates an example of a system for machine generated code development efficiency ratings and code development insights, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

Systems and methods are provided for machine generated code development efficiency ratings and code development insights. Developers may collaborate together on software projects for developing software, such as an application, a service, or a website. An organization may assign a developer working on a software project to perform a task that involves particular code of the software project, such as to create login and logout functionality. The developer may spend a certain amount of time, effort, resources, and iterations to create the login and logout functionality in an acceptable state such as for production. Each iteration may involve the developer checking out code, modifying the code, submitting the code for review, and/or committing the code to the project.

A code development efficiency of the developer may depend on a multitude of factors, such as a current state of the code (e.g., bad with a lot of errors, average with some errors, good, excellent, etc.), a number of iterations by the developer working on the code until the code satisfies functionality requirements such as exit criteria, an amount of review and oversight, thoroughness of documentation, unit test case (UTC) information, etc. More efficient code development will result in less error prone code, less bugs being released into production, more efficient resource utilization when developing code, identifying and improving any code development weaknesses of developers, etc.

Unfortunately, it is difficult to manually ascertain the code development efficiency of a developer. For example, a first developer may work on good code to turn the good code into excellent code, while a second developer may spend the same time and/or effort to turn bad code into excellent code. The second developer may have better code development efficiency compared to the first developer. However, the first developer may appear to be a more efficient code developer if the first developer self-promotes to a manager to a much greater degree than the second developer. Thus, human biases, inaccuracies, and/or a lack of complete knowledge about a current state of code and what is required to make the code production worthy make it difficult to manually ascertain the code development efficiencies of developers.

The disclosed techniques overcome these technical problems by utilizing custom machine learning models that are custom tailored to generate code development efficiency ratings and code development insights for improving the efficiency of code development and reducing the errors and functionality issues that could be introduced when releasing code for production. The disclosed techniques train and customize a model using custom prompts and specific parameters that are tailored based the particular code being developed and information about the developers working on the code. The model is trained and customized to generate outputs as part of evaluating the efficiency of the developers and to generate recommendations on how to improve the code and/or address potential issues and bugs. In this way, customized prompts and inputs are constructed for controlling the model to generate the outputs. The outputs may describe the code development efficiency of developers. In some embodiments, outputs may include recommendations for improving code, which may be recommended to a user or automatically implemented to modify/fix code, for example. In some embodiments, the prompts and inputs relate to a current state of code that a developer worked on, evaluation metrics for the user such as a number of iterations it took the developer to transform the code into an acceptable state for production, and/or a variety of other considerations. In this way, the output from the model is used to generate code development efficiency ratings and code development insights.

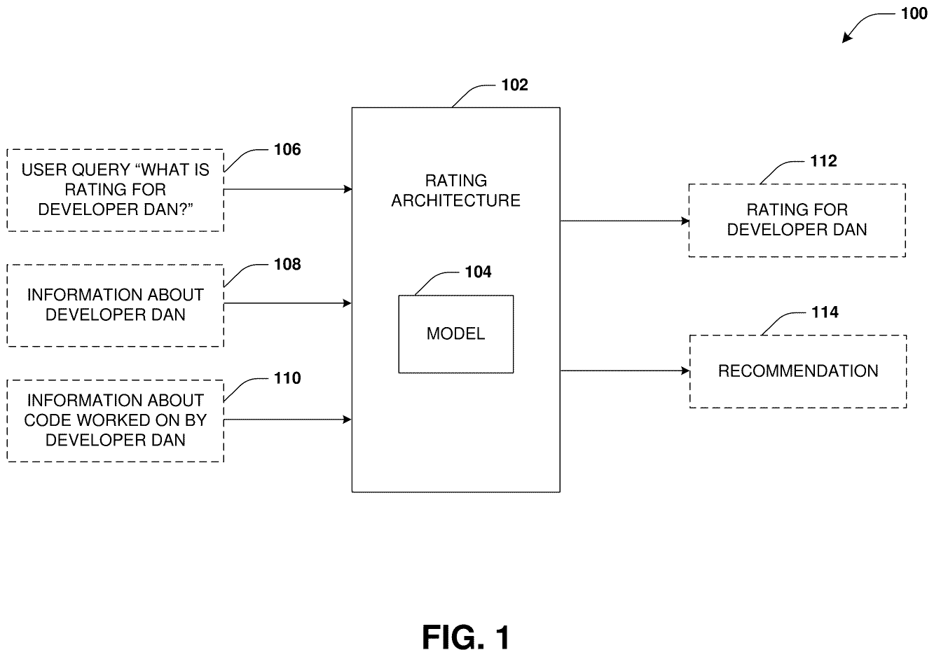

FIG. 1 illustrates an example of a system 100 for machine generated code development efficiency ratings and code development insights. The system 100 includes a rating architecture 102. In some embodiments, the rating architecture 102 hosts or has access to a model 104 (e.g., an artificial intelligence and/or machine learning model; a large language model; Gemini; Llama; etc.). The model 104 may be trained and custom configured using customized prompts to generate outputs related to code development efficiency. The code development efficiency corresponds to how efficient a user is at developing code. The model 104 may be trained and custom configured to generate recommendations of how to improve code and address potential issues and bugs in the code.

Various information may be used to generate inputs for the model 104. The information may take into account both the code and the user. For example, the rating architecture 102 may receive a user query 106 such as through an interface. The user query 106 may request a rating for a user such as a rating for developer Dan working on certain code of a particular project (e.g., code corresponding to functionality of a checkout page for a shopping app). Accordingly, the rating architecture 102 may evaluate information 108 related to actions performed by the user with respect to a software development platform. The actions may relate to the user checking out code, modifying code, committing code changes, issuing pull requests to create, modify, or delete code, performing iterations of code updates, submitting code changes for review, receiving feedback from a review performed for code submitted by the user, etc. The information 108 may be used as input into the model 104.

The rating architecture 102 may evaluate information 110 related to code worked on by the user. The information 110 may correspond to a current state of the code, such as whether the code is in a bad state, an average state, a good state, an excellent state, etc. In some embodiments, the information 110 may be received from a code quality analysis service (e.g., SonarQube). The information 110 may be used as input into the model 104. It may be appreciated that a variety of other information may be input into the model 104, such as backlogs created towards each iterative deliverable of the code, automated code review comments and comment severity information, summarizations of code, information extracted from pull requests for the code, code style and documentation created for the code, quality of test cases created for the code, repeated bugs on the code by the same author/developer, acceptance criteria (functional requirements, exit criteria, criteria for good code, etc.), and/or a variety of other information about the user and/or code. The information is input as parameters into the model 104 for processing.

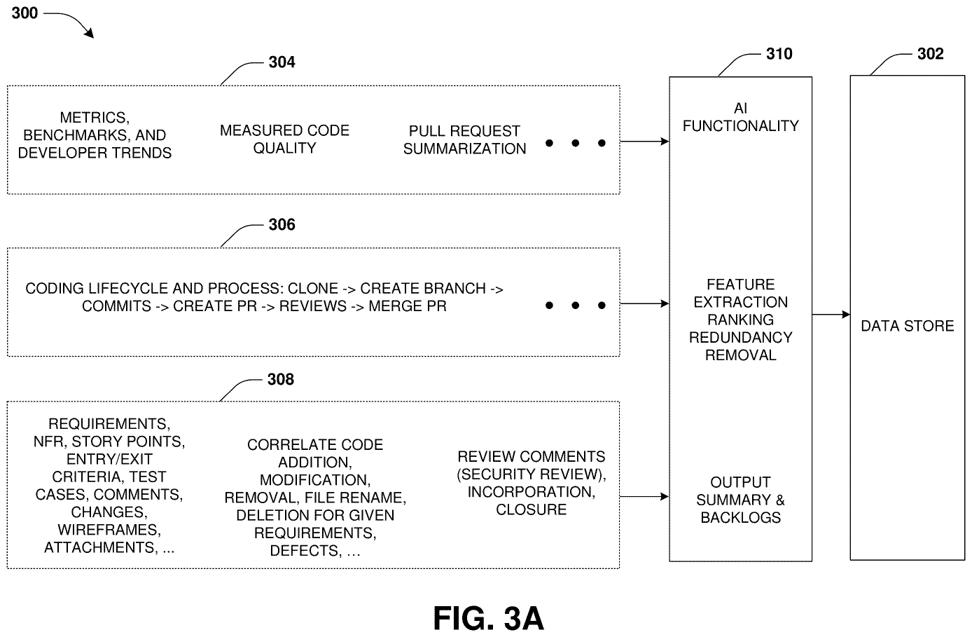

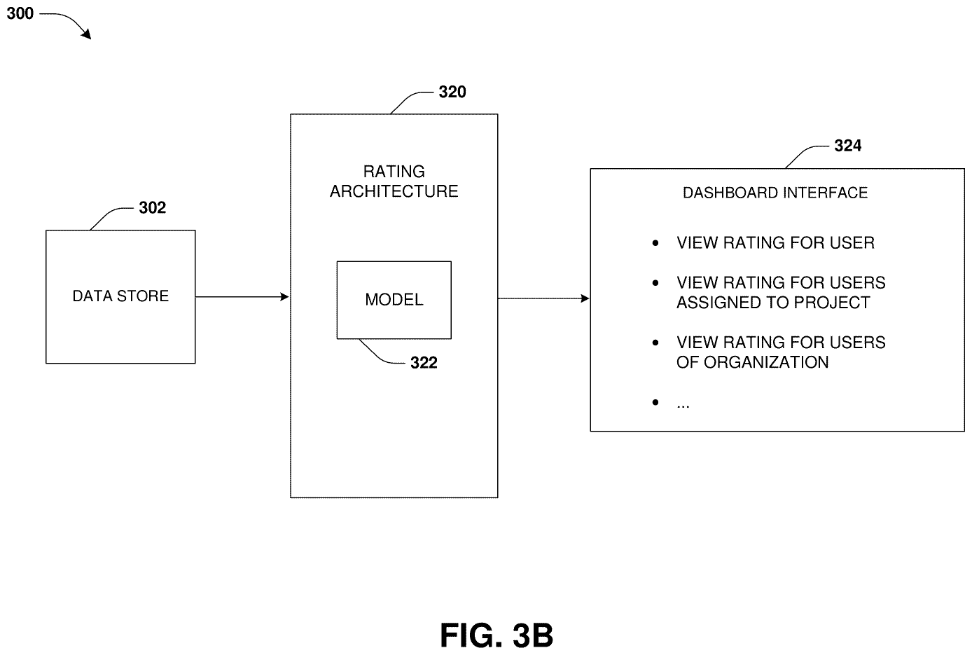

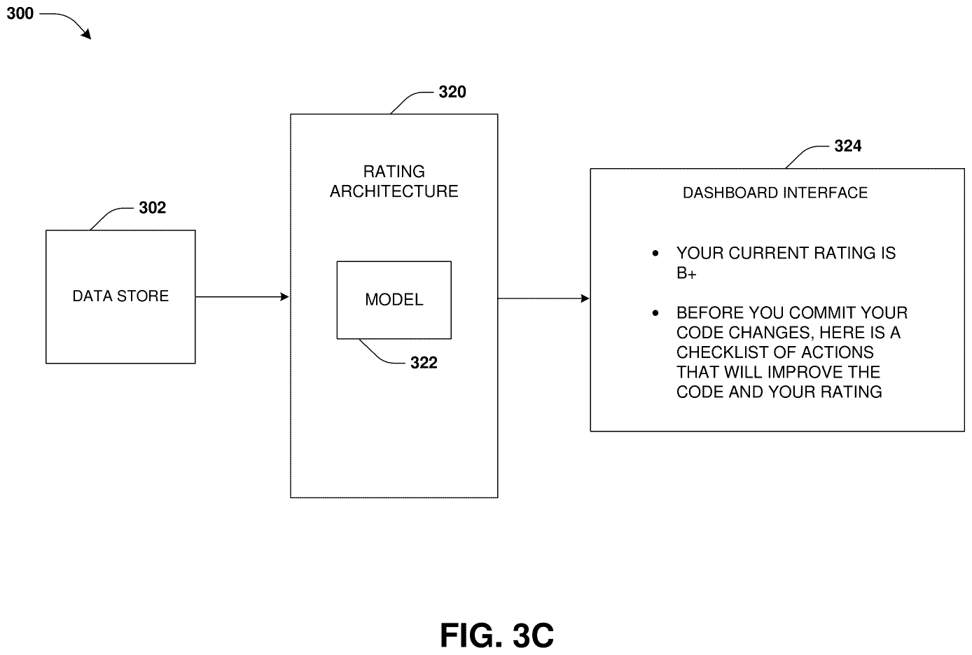

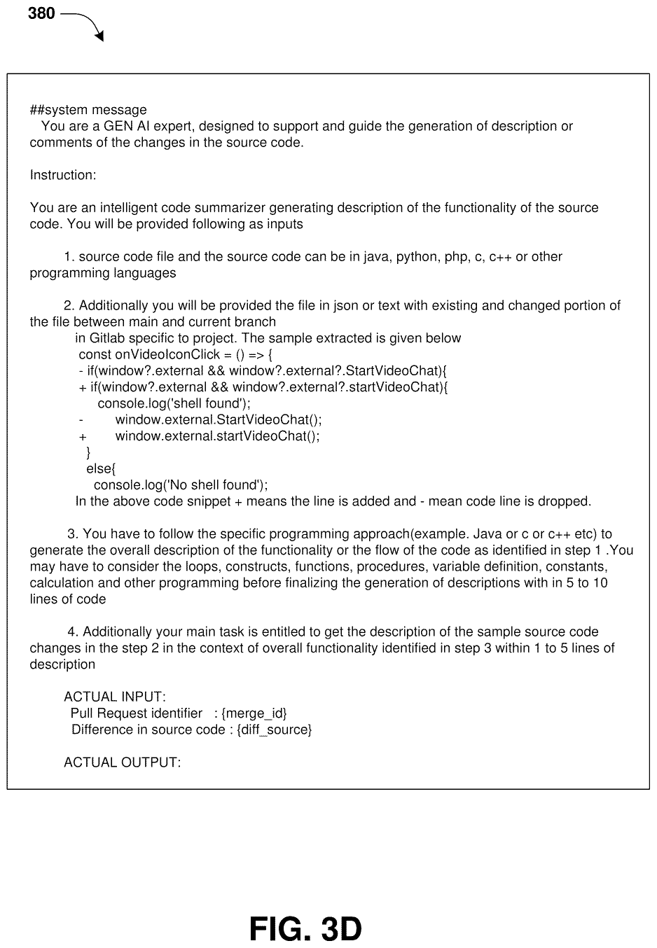

The model 104 is controlled using a custom prompt with instructions to generate the output. The custom prompt may instruct the model 104 to behave as a generative AI expert designed to support and guide the generation of description or comments of changes in source code. The custom prompt may instruct the model 104 to be an intelligent code summarizer that generates descriptions of functionality of source code. The custom prompt may define inputs, such as a source code file, changes to source code, pull requests, etc. An embodiment of the custom prompt is illustrated by example prompt 380 of FIG. 3D. The example prompt 380 provides a system message for the model 104, instructions for the model 104, and inputs that the model 104 is to utilize.

As shown in FIG. 3D, the prompt may be something similar to the following:

##system message
You are a GEN AI expert, designed to support and guide the generation of description or
comments of the changes in the source code.
Instruction:
You are an intelligent code summarizer generating description of the functionality of the
source
code. You will be provided following as inputs
1. source code file and the source code can be in java, python, php, c, c++ or other
programming languages
2. Additionally you will be provided the file in json or text with existing and changed portion
of
the file between main and current branch
in Gitlab specific to project. The sample extracted is given below
const on VideoIconClick = ( ) => {
− if(window?. external && window?.external?.Start VideoChat) {
+ if(window?.external && window?.external?.start VideoChat){
console.log(‘shell found’);
− window.external.StartVideoChat( );
+ window.external.startVideoChat( );
}
else{
console.log(‘No shell found’);
In the above code snippet + means the line is added and − mean code line is dropped.
3. You have to follow the specific programming approach(example. Java or c or c++ etc) to
generate the overall description of the functionality or the flow of the code as identified in step
1.You
may have to consider the loops, constructs, functions, procedures, variable definition,
constants,
calculation and other programming before finalizing the generation of descriptions with in 5 to
10
lines of code
4. Additionally your main task is entitled to get the description of the sample source code
changes in the step 2 in the context of overall functionality identified in step 3 within 1 to 5
lines of
description
ACTUAL INPUT:
Pull Request identifier : {merge_id}
Difference in source code : { diff_source }
ACTUAL OUTPUT:

Other similar custom prompts may be used in order to instruct the model 104 to behave as a generative AI expert designed to support and guide the generation of description or comments of changes in source code.

Utilizing the custom prompt and the inputs, the model 104 may generate a rating 112 for the user. The rating 112 may relate to how efficient the user is with developing code. A low rating may indicate that the user takes a lot of iterations and/or review to transform code from one state to another state (e.g., transform code from a bad state to a good state). A high rating may indicate that the user does not take a lot of iterations and/or review to transform the code from one state to another state. In some embodiments, the model 104 outputs a recommendation 114 for the user and/or for code assigned to the user (e.g., code that the user is attempting to commit back to a project). The recommendation 114 may identify code errors, suggest code modifications for addressing the code errors, recommend changes that the user can make to improve the rating 112, explain why the user received the rating 112, etc. In some embodiments, the rating architecture 102 may automatically or in response to user input execute any code modification suggestions, such as to address code errors identified by the model 104 from the input. In this way, the rating architecture 102 provides machine-aided insight and remediation to improve code, reduce bugs, improve coding efficiency, and reduce human error.

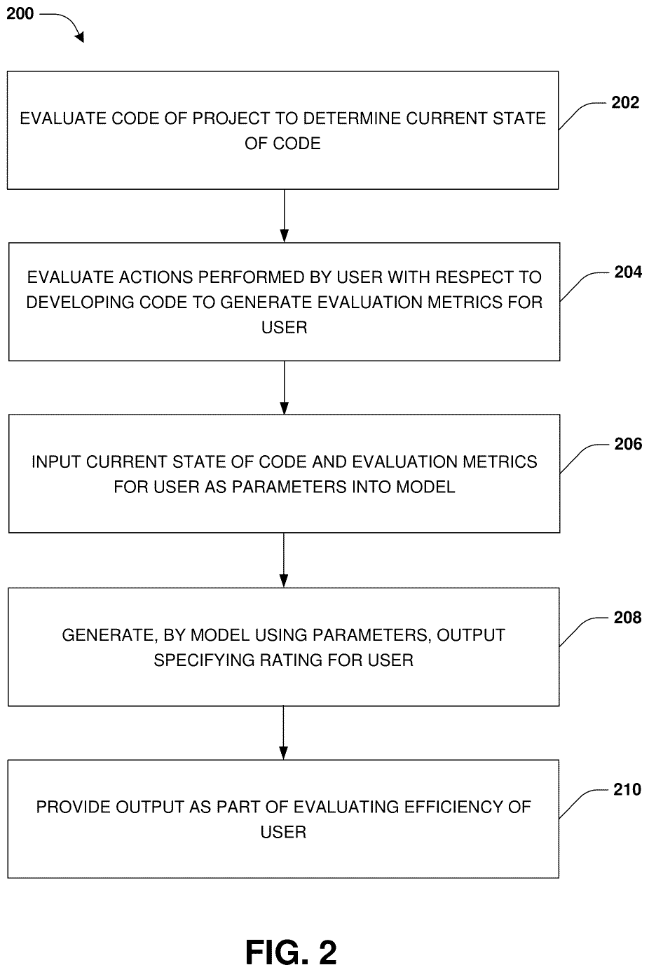

FIG. 2 illustrates an example of a method 200 for machine generated code development efficiency ratings and code development insights. In some embodiments, the method 200 may be implemented by the rating architecture 102 of FIG. 1, such as by a computer, server, virtual machine, cloud compute and storage, etc. The method 200 may be invoked as part of training the model 104 and/or as part of controlling the model 104 such as through custom prompting to generate code development efficiency ratings and code development insights. In some embodiments, the method 200 is invoked in response to a request received through an interface for a current rating of one or more developers, which may be defined at a particular granularity. The granularity may relate to a single developer, developers assigned to a manager, developers working on a project, developers on a team, developers of an organization, etc. In this way, the model 104 may be used to rank the efficiency of one or more users.

During operation 202 of method 200, code of a project may be evaluated to determine a current state of the code with respect to the code satisfying functional requirements. For example, the code may relate to checkout code of a shopping website assigned to a user to develop. For example, the user may be assigned to create payment processing functionality for the checkout code and to update a checkout user interface. The functional requirements may relate to exit criteria that must be satisfied in order for the code to be released for production. The current state of the code may relate to whether the code is in a bad state (e.g., code with missing functionality, bugs, commands that are inoperable, commands that do not function as intended, or other issues), an average state, a good state, an excellent state, or any other type of state (e.g., a state determined by a code quality analysis service such as SonarQube).

During operation 204 of method 200, actions performed by the user with respect to developing the code are evaluated to generate evaluation metrics for the user. The actions may relate to the user checking out the code from the project, modifying the code, submitting the code for review, feedback/comments received as part of the review, committing the code back to the project, and/or iterations of the user modifying and committing the code to the project.

During operation 206 of method 200, the current state of the code, the evaluation metrics for the user, and/or other information may be input into the model as parameters for generating an output. In some embodiments of other information that may be input into the model, pull requests for the code may be retrieved. The pull requests may relate to requests for new code to be integrated into a main repository of the project. The pull requests or other information about the code may be used to generate a summarization of the code, such as a textual description of the code that is stored into a textual embedding. The textual embedding, used to store the summarization, may be populated into a vector database used as input into the model. In some embodiments of other information that may be input into the model, backlogs may be input as parameters into the model. The backlogs may be created as part of an iterative deliverable for the project. In some embodiments of other information that may be input into the model, code review comments and comment severity information (e.g., a minor suggestion vs a required change) may be input as parameters into the model.

In some embodiments of other information that may be input into the model, code style and documentation may be input as parameters into the model. In some embodiments of other information that may be input into the model, quality of test cases created for the project may be input as parameters into the model. In some embodiments of other information that may be input into the model, instances of bugs in the project from the user may be input as parameters into the model (e.g., did the project have a bug or error locate in code that was accessed and/or modified by the user). In some embodiments of other information that may be input into the model, acceptance criteria for the project may be input as parameters into the model (e.g., functionality requirements and/or exit criteria for code to be acceptable and ready for production).

During operation 208 of method 200, the model may utilize the parameters and/or a custom prompt input into the model to generate an output specifying a rating for the user. That rating may correspond to how efficient the user is at code development. In some embodiments, the model may evaluate a percentage of a task assigned to the user to perform for the code (e.g., a percentage of completed sub-tasks) as part of generating the output. Thus, an efficiency of the user performing the sub-tasks is taken into account when outputting the rating for the user. The more sub-tasks that the user has not completed, the lower the rating. In some embodiments, the rating may represent a code developer efficiency of the user. The higher the rating, the less iterations it may take for the developer to transform bad code into good code. In some embodiments, the output may include rating information for a developer, developers assigned to a manager, developers on the project, developers on a team, or developers of an organization, and thus developers may be rated and ranked according to their code development efficiency. In some embodiments, the output may relate to code metrics that may identify any issues or problems with the code to fix. During operation 210 of method 200, the output may be provided, such as through the interface, as part of evaluating an efficiency of the user with respect to developing code. The rating may specify a number (e.g., a numerical scale from 1 to 10), a letter grade, a description (e.g., low efficiency, average efficiency, high efficiency), or some other indicator (e.g., a percentile ranking compared to other developers) that can be used to compare the user to other users.

In some embodiments, the output is used to generate a recommendation for the user to implement for developing the code to satisfy the functional requirements. The recommendation may identify bugs within the code, issues within the code, inefficient code, functionality not working, errors, and/or suggestions for how to fix the issues so that the code may satisfy the functionality requirements. In some embodiments, the suggestions may be executed by the rating architecture 102 to modify and fix the code. In some embodiments, the recommendation may be provided to the user during a code commit phase as feedback for improving the efficiency of the user.

In some embodiments, the output is used to generate a checklist of actions for the user to implement for developing the code to satisfy code standards, efficient unit testing, and/or automated review comments and documentation. The actions may relate to code modifications for the user to consider (e.g., code or functionality to add, modify, or remove). In some embodiments, the checklist may be provided to the user during a code commit phase as feedback for improving the efficiency of the user.

In some embodiments, the model may be updated/trained with new information over time. For example, incremental updates to the code may be identified (e.g., code modifications, new code, deletions to code, etc.). A retrieval augmented generation model may be used to generate a delta from the incremental updates (e.g., a delta of what changed with the code). The delta may be generated to include a new current status of the code (e.g., the code is an in average state) and/or used to identify new actions performed by the user (new evaluation metrics). In this way, the delta may be input into the model for updating/training the model.

FIGS. 3A-3C illustrate an example of a system 300 for machine generated code development efficiency ratings and code development insights. A model 322 may take information stored within a data store 302 as input parameters for generating an output, as illustrated by FIG. 3A. A first set of information 304 may relate to metrics, benchmarks, and developer trends that may be accessed through webhooks. The first set of information 304 may include measured code quality corresponding to a current state of the code (e.g., Git pre-commit hooks to measure code quality at time of branch creation, which may be used to measure developer backlog items during push requests). The first set of information 304 may include pull request summarizations that summarize the code through execution of a workflow (e.g., iterative code summarization of GIT merge operations). The first set of information 304 may be processed by functionality 310 as part of being stored into the data store 302. The functionality 310 may include AI functionality (e.g., Gemini), feature extraction, ranking, and redundancy removal, and/or output summary and backlogs. The first set of information 304 may be retrieved as part of an on-going or periodic basis.

A second set of information 306 may include information related to a coding lifecycle and process, which may include stages such as code cloning to preserve a current state of code, branch creation, commits, pull request creation, reviews, and pull request merge. The second set of information 306 may be processed by the functionality 310 as part of being stored into the data store 302.

A third set of information 308 may include requirements, non-functional requirements (NFRs), story points, entry and exit criteria, test cases, comments, changes, wireframes, attachments, and/or other information (e.g., information extracted from Jira). The third set of information 308 may include defects on a current iteration of the code being modified, submitted for review, or being committed back to the project. The third set of information 308 may include correlations to code additions, modifications, removal, file renames, deletions with respect to given requirements, defects using a commit process (e.g., a GIT Jira commit process), etc. The third set of information 308 may include review comments and/or security review results, incorporations (e.g., modifications of the code to satisfy the comments and/or security review results), and/or closure.

In this way, various information may be stored within the data store 302 for use as input parameters for the model 322 hosted by a rating architecture 320, as illustrated by FIG. 3B. The model 322 may utilize the information within the data store 302 to generate outputs that may be provided through a dashboard interface 324. The outputs may be used to provide ratings for a user, ratings for users assigned to a project, ratings for users of an organization, etc. For example, the dashboard interface 324 may be populated with a current rating of B+ for a user based upon the output from the model 322, as illustrated by FIG. 3C. Based upon the output from the model 322, the dashboard interface 324 may be populated with a recommendation and/or checklist of actions that the user can perform to improve the code and/or the rating (e.g., actions to fix bugs, finish uncompleted sub-tasks, improve the quality of the code for satisfying functional requirements such as exit criteria, etc.).

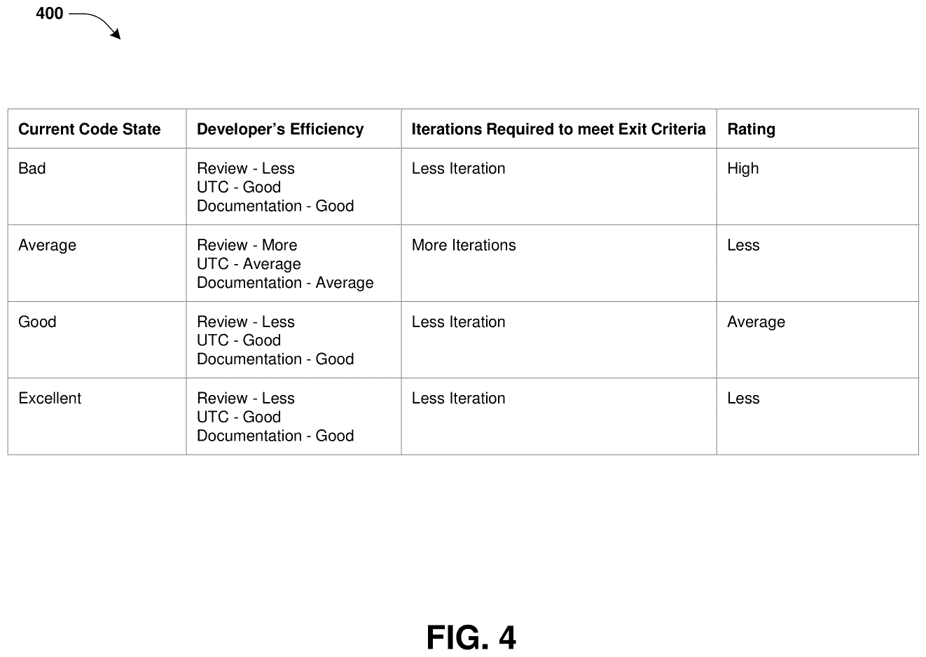

FIG. 4 illustrates an example chart 400 of code development efficiency ratings that include a current code state for code, development efficiencies of developers, iterations required for code to satisfy exit criteria (functional requirements), and/or ratings for users. A first user may have a high rating because a model determined that the first user has a high code development efficiency. The first user may have worked on code that initially had a bad code state. An efficiency of the first user may relate to having less reviews than average, good unit test cases, and good documentation, along with performing less iterations than average to transform the code from the bad code state to a code state that satisfies the exit criteria.

A second user may have a less than average rating because the model determined that the second user has a less than average development efficiency. The second user may have worked on code that initially had an average code state. An efficiency of the second user may relate to having more reviews than average, average unit test cases, and average documentation, along with performing more iterations than average to transform the code from the average code state to a code state that satisfies the exit criteria.

A third user may have an average rating because the model determined that the third user has an average development efficiency. The third user may have worked on code that initially had a good code state. An efficiency of the third user may relate to having less reviews than average, good unit test cases, and good documentation, along with performing less iterations than average to transform the code from the good code state to a code state that satisfies the exit criteria.

A fourth user may have a less than average rating because the model determined that the fourth user has a less than average development efficiency. The fourth user may have worked on code that initially had an excellent code state. An efficiency of the fourth user may relate to having less reviews than average, good unit test cases, and good documentation, along with performing less iterations than average to transform the code from the excellent code state to a code state that satisfies the exit criteria.

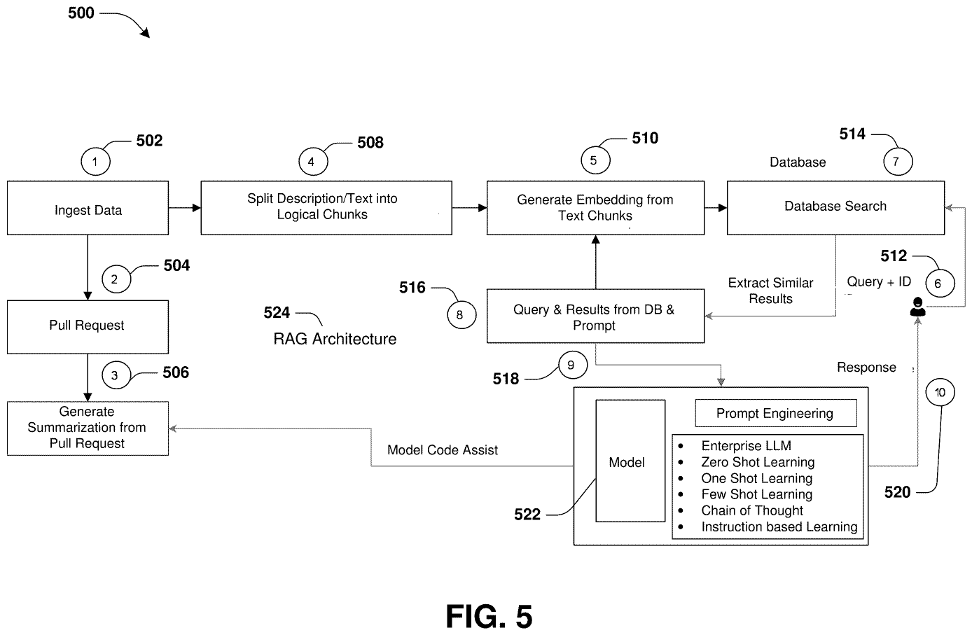

FIG. 5 illustrates an example of a system 500 for machine generated code development efficiency ratings and code development insights. The system 500 may implement data ingestion 502, such as where data from Jira or other sources is obtained for a project and/or for developers. The system 500 may evaluate 504 pull requests to extract code changes that were made to code of the project. The system 500 may generate 506 summarizations of the code from the pull requests, which are input into the model 522 hosted by a rating architecture, such as through model code assist (e.g., Gemini/Llama code assist).

The system 500 may split 508 the ingested data, such as Jira and GitLab descriptions and text, into logical chunks. The system may generate 510 text embeddings from the logical chucks (e.g., embeddings with quantization). The text embeddings may summarize the code of the project. The text embeddings may be stored within a vector database. When a user submits 512 a query for a rating, the vector database may be searched 514 to obtain the text embeddings. The text embeddings may be used as knowledge extensions for the model 522 such as a large language model. In response to the query, search results may be obtained from the vector database. Accordingly, the query, top results from the vector database, and a customized prompt may be generated 516 and input 518 into the model 522. The model 522 may have been trained by the rating architecture through zero shot learning, one shot learning, few shot learning, chain of through instruction based learning, enterprise LLM training, and/or prompt engineering to generate an output as a response 520 to the user. The response 520 may include a rating for a developer.

A retrieval augmented generation (RAG) architecture 524 may be used to update the model 522 over time based upon incremental updates to the code. The RAG architecture 524 may generate a delta from the incremental updates, and input the delta into the model 522 to update/train the model 522. In this way, the model 522 is maintained in an up-to-date state for generating accurate ratings and recommendations that are relevant to a current codebase of a project.

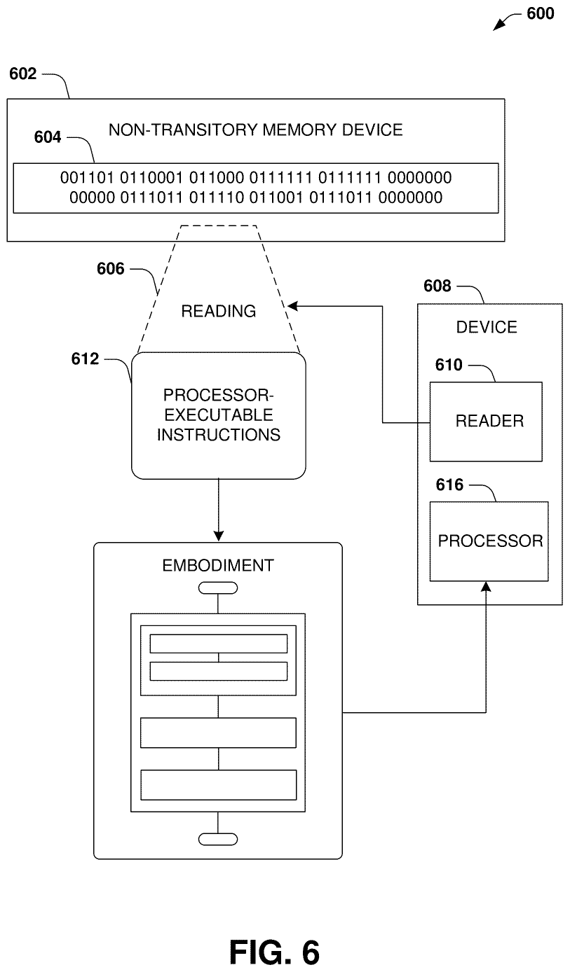

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1 and/or at least some of the example system 300 of FIGS. 3A-3C, for example.

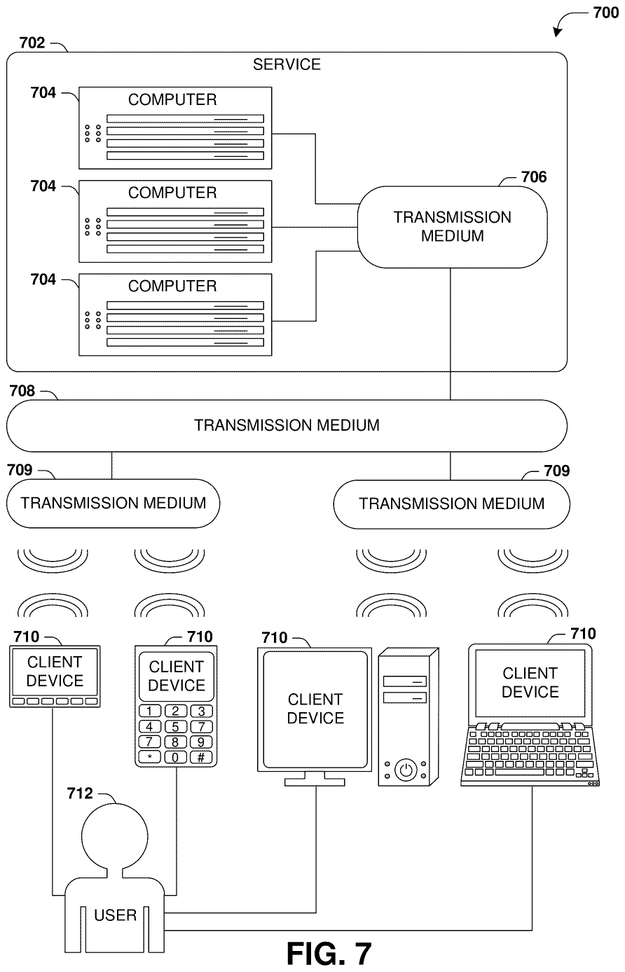

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

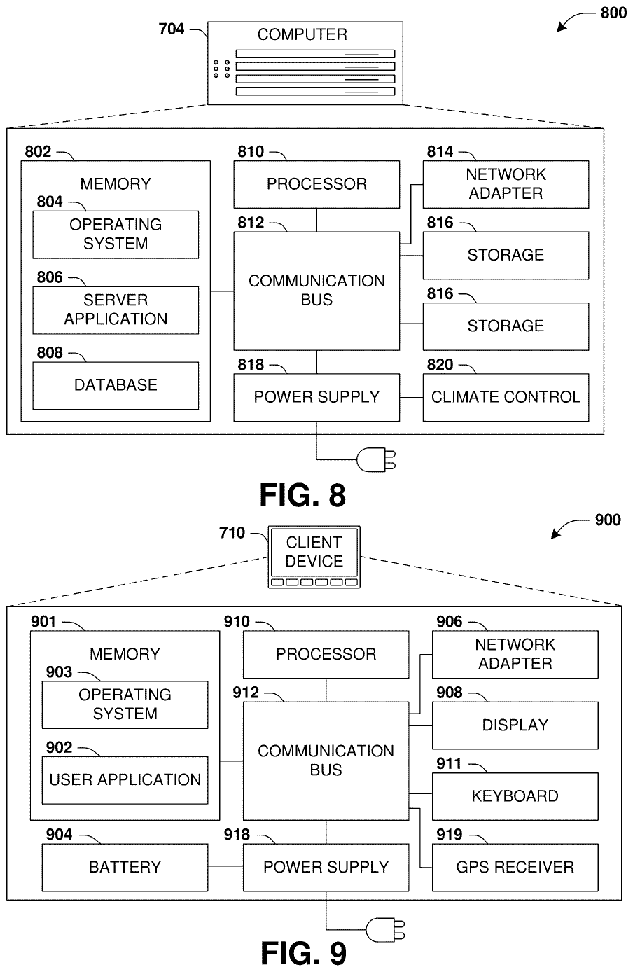

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
evaluating code of a project to determine a current state of the code with respect to the code satisfying functional requirements;
evaluating actions performed by a user with respect to developing the code to generate evaluation metrics for the user;
inputting the current state of the code and the evaluation metrics for the user as parameters into a model;
generating, by the model using the parameters, an output specifying a rating for the user; and
providing the output as part of evaluating an efficiency of the user.

2. The method of claim 1, comprising:
retrieving pull requests for the code;
generating a summarization of the pull requests to summarize the code; and
inputting the summarization into the model as a parameter.

3. The method of claim 1, comprising:
inputting a backlog created as part of an iterative deliverable for the project as a parameter into the model.

4. The method of claim 1, comprising:
inputting code review comments and comment severity information as parameters into the model.

5. The method of claim 1, comprising:
inputting code style and documentation as parameters into the model.

6. The method of claim 1, comprising:
inputting quality of test cases created for the project as parameters into the model.

7. The method of claim 1, comprising:
inputting instances of bugs in the project from the user as parameters into the model.

8. The method of claim 1, comprising:
inputting acceptance criteria for the project as parameters into the model.

9. A system, comprising:
one or more processors configured for executing instructions to perform operations comprising:
evaluating code of a project to determine a current state of the code with respect to the code satisfying functional requirements;
evaluating actions performed by a user with respect to developing the code to generate evaluation metrics for the user;
inputting the current state of the code and the evaluation metrics for the user as parameters into a model;
generating, by the model using the parameters, an output specifying a rating for the user; and
providing the output as part of evaluating an efficiency of the user.

10. The system of claim 9, wherein the operations further comprise:
generating, by the model, the output to represent code developer efficiency and code metrics.

11. The system of claim 9, wherein the operations further comprise:
utilizing the output to generate a recommendation for the user to implement for developing the code to satisfy the functional requirements; and
providing the recommendation during a code commit phase.

12. The system of claim 9, wherein the operations further comprise:
utilizing the output to generate a checklist for the user to implement for developing the code to satisfy at least one of code standards, efficient unit testing, or automated review comments and documentation; and
providing the checklist during a code commit phase.

13. The system of claim 9, wherein the operations further comprise:
identifying incremental updates to the code;
utilizing a retrieval augmented generation model to generate a delta from the incremental updates; and
inputting the delta into the model.

14. The system of claim 9, wherein the operations further comprise:
receiving, through an interface, a request for a current rating of a developer; and
utilizing the model to generate and provide the current rating through the interface.

15. The system of claim 9, wherein the operations further comprise:
receiving, through an interface, a request for rating information for users at a specified granularity; and
utilizing the model to generate and provide the rating information through the interface.

16. A non-transitory computer-readable medium storing instructions that when executed by one or more processors facilitate performance of operations comprising:
evaluating code of a project to determine a current state of the code with respect to the code satisfying functional requirements;
evaluating actions performed by a user with respect to developing the code to generate evaluation metrics for the user;
inputting the current state of the code and the evaluation metrics for the user as parameters into a model;
generating, by the model using the parameters, an output specifying a rating for the user; and
providing the output as part of evaluating an efficiency of the user.

17. The non-transitory computer-readable medium of claim 16, wherein the operations further comprise:
evaluating, by the model, a percentage of sub-tasks of a task assigned to the user to perform for the code, wherein the model generates the output based upon the percentage.

18. The non-transitory computer-readable medium of claim 16, wherein the operations further comprise:
identifying the actions performed by the user as iterations of the user modifying the code for commitment to the project.

19. The non-transitory computer-readable medium of claim 16, wherein the operations further comprise:
generating a textual embedding with a summarization about the code; and
storing the textual embedding into a vector database used as input into the model.

20. The non-transitory computer-readable medium of claim 16, wherein the operations further comprise:
generating the output to include rating information at a granularity corresponding to at least one of a single developer granularity, developers assigned to a manager, developers on a project, developers on a team, or developers of an organization.
